(19) United States
(12) Patent Application Publication
(10) Pub. No.: US 2002/0123990 A1
(43) Pub. Date: Sep. 5, 2002

(54) Apparatus and method for processing information, information system, and storage medium

(76) Inventors: Mototsugu Abe, Tokyo (JP); Masayuki Nishiguchi, Kanagawa (JP); Kenzo Akagiri, Kanagawa (JP)

Correspondence Address: SONNENSCHEIN NATH & ROSENTHAL, P.O. BOX 061080, WACKER DRIVE STATION, CHICAGO, IL, 60606-1080, US

(21) Appl. No.: 09/934,393

(22) Filed: Aug. 21, 2001

(30) Foreign Application Priority Data
Aug. 22, 2000 (JP) P2000-250530

(51) Int. Cl. G06F 17/30; G06F 7/00; G06F 17/00

(52) U.S. Cl. 707/3; 707/104.1

(57) ABSTRACT

A search processor determines whether a search query has been received. When it is determined that the search query has been received, the search processor acquires the search query, calculates the degree of similarity of the search query, and deletes a content having the degree of similarity equal to or smaller than a predetermined threshold. When no search query has been received, the search processor determines whether the number of contents in a candidate list is equal to or larger than a predetermined number. When it is determined that the number of contents is equal to or larger than the predetermined number, the search processor issues an additional question. A content is thus searched in an interactive fashion based on fuzzy information.

### BACKGROUND OF THE INVENTION

1. Field of the Invention

The present invention relates to an information processing, an information processing apparatus, an information processing system, and a storage medium, and more particularly to information processing method and apparatus which allows contents to be searched for in an interactive fashion according to fuzzy information provided by a user, an information processing system incorporating such apparatus, and a storage medium storing program code for such information processing method.

2. Description of the Related Art

A variety of electronic commerce transactions are performed as network systems such as the Internet are in widespread use. For example, a shopper may select and purchase a commodity from a catalog presented on a home page. When a shopper already knows the name of a commodity, he may directly enter the commodity name for purchasing on a network system.

The electronic commerce is effective when shoppers have the knowledge of the commodity to purchase.

When an item to purchase is a video program or music (contents), a shopper may have a vague impression or fuzzy memory of a content, such as scenes of a video program, part of a melody, part of lyric, part of speech, or clips of a preview or advertisement, and may frequently fail to name exactly a content (a title), a player's name, or a composer's name.

In conventional commerce transactions, the name of a commodity wanted by a shopper may be identified when the shopper explains to a shop keeper a vague impression of the commodity. In a store, the shopper may listen to music or preview a video program on a trial mode for identification. In other words, a shopper can still buy a commodity based on fuzzy information.

However, in the electronic commerce, a shopper cannot buy a content based on fuzzy information.

### SUMMARY OF THE INVENTION

Accordingly, it is an object of the present invention to allow contents to be searched for in an interactive fashion according to fuzzy information provided by a user.

The present invention in one aspect relates to an information processing apparatus and includes a storage unit for storing a candidate list in which contents are registered, a calculation unit for calculating the degree of similarity of the contents registered in the candidate list according to search conditions input from the other apparatus, a deleting unit for deleting a content from the candidate list when it is determined that the degree of similarity of the content calculated by the calculation unit is smaller than a predetermined threshold, and a presentation unit for presenting a question to the other apparatus when the total number of contents remaining in the candidate list as a result of the deletion by the deleting unit is equal to or larger than a predetermined number, wherein when the question is presented, the calculation unit further calculates the degree of similarity of the contents registered in the candidate list according to search conditions additionally input from the other apparatus.

The information processing apparatus preferably includes a transmitter for transmitting the candidate list to the other apparatus when the total number of contents remaining in the candidate list as a result of the deletion by the deleting unit is smaller than the predetermined number, and a delivery unit for delivering the content to the other apparatus when a request to supply the content registered in the candidate list transmitted from the transmitter is received from the other apparatus.

The information processing apparatus may further include an acquisition unit for acquiring user information from the other apparatus, and an authentication unit for authenticating the user information acquired by the acquisition unit, wherein the delivery unit delivers the content based on the authentication result provided by the authentication unit.

The information processing apparatus may further include a recording unit for recording, in the candidate list, the degree of similarity calculated by the calculation unit, and a position having a similarity in the content.

The content may contain one of video data and music data.

A format of the search condition may contain a text, a text relating to music, a video program, a voice, a singing voice, humming, or music.

The search condition may include, in whole or in part, a title of music, a name of a player, a name of a composer, a name of a lyric writer, a name of a conductor, a genre of the music, lyric, the music, performance by humming or singing voice, information relating to the music, speech, a name of an actor, a video program, reproduction of the video program, and information relating to the video program.

The present invention in another aspect relates to an information processing method and includes the steps of storing a candidate list in which contents are registered, calculating the degrees of similarity of the contents registered in the candidate list according to search conditions input from the other apparatus, deleting a content from the candidate list when it is determined that the degree of similarity of the content calculated by the calculation step is smaller than a predetermined threshold, and presenting a question to the other apparatus when the total number of contents remaining in the candidate list as a result of the deletion by the deleting step is equal to or larger than a predetermined number, wherein when the question is presented, the calculation step further calculates the degrees of similarity of the contents registered in the candidate list according to search conditions additionally input from the other apparatus.

The present invention in yet another aspect relates to a storage medium for storing a computer readable program. The program includes a program code for a step of storing a candidate list in which contents are registered, a program code for a step of calculating the degrees of similarity of the contents registered in the candidate list according to search conditions input from the other apparatus, a program code for a step of deleting a content from the candidate list when it is determined that the degree of similarity of the content calculated in the calculation step is smaller than a predetermined threshold, and a program code for a step of presenting a question to the other apparatus when the total number of contents remaining in the candidate list as a result of the deletion in the deleting step is equal to or larger than a predetermined number, wherein when the question is presented, the calculation step further calculates the degrees of similarity of the contents registered in the candidate list according to search conditions additionally input from the other apparatus.

In the program used in the information processing method and stored in the information processing apparatus, and the storage medium, the degrees of similarity of the contents registered in the candidate list are calculated according to search conditions input from the other apparatus. When it is determined that the degree of similarity of the content calculated by the calculation unit is smaller than a predetermined threshold, the candidate content is deleted from the candidate list. When the total number of contents remaining in the candidate list as a result of the deletion by the deleting step is equal to or larger than a predetermined number, a question is presented to the other apparatus. The degrees of similarity of the contents registered in the candidate list are calculated according to search conditions additionally input from the other apparatus.

The present invention in still another aspect relates to an information processing system and includes a first information processing apparatus and a second information processing apparatus. The first information processing apparatus includes a storage unit for storing a candidate list in which contents are registered, a calculation unit for calculating the degrees of similarity of the contents registered in the candidate list according to search conditions input from the second information processing apparatus, a deleting unit for deleting a content from the candidate list when it is determined that the degree of similarity of the content calculated by the calculation unit is smaller than a predetermined threshold, and a presentation unit for presenting a question to the second information processing apparatus when the total number of contents remaining in the candidate list as a result of the deletion by the deleting unit is equal to or larger than a predetermined number. The second information processing apparatus includes a first transmitter for transmitting, to the first information processing apparatus, the search conditions for searching the contents, a receiver for receiving the question presented by the first information processing apparatus, and a second transmitter for transmitting, to the first information processing apparatus, an additional search condition when answering the question received from the receiver.

In the information processing system of the present invention, the first information processing apparatus calculates the degrees of similarity of the contents registered in the candidate list according to search conditions input from the second information processing apparatus. When it is determined that the degree of similarity of the content calculated by the calculation unit is smaller than a predetermined threshold, the content is deleted from the candidate list. When the total number of contents remaining in the candidate list is equal to or larger than a predetermined number, a question is presented to the second information processing apparatus. The second information processing apparatus transmits, to the first information processing apparatus, the search conditions for searching the contents. When the second information processing apparatus answers the question presented from the first information processing apparatus, the additional search condition is sent to the first information apparatus.

### BRIEF DESCRIPTION OF THE DRAWINGS

FIG. 1 is a block diagram showing a search system implementing the present invention;

FIG. 2 is a block diagram showing a server system of FIG. 1;

FIG. 3 is a block diagram showing a terminal of FIG. 1;

FIG. 4 is a block diagram showing a search server of FIG. 2;

FIG. 5 shows a search query;

FIG. 6 shows a candidate list;

FIG. 7 is a flow diagram showing a delivery process of a content;

FIG. 8 is a continuation of the flow diagram of FIG. 7;

FIG. 9 shows a display example presented on an initial entry screen;

FIG. 10 shows a display example presented on an additional question screen;

FIG. 11 shows a display example on an aborted search notification screen;

FIG. 12 shows a display example on a candidate list screen;

FIG. 13 shows a display example on a prelistening or previewing screen;

FIG. 14 shows a display example on a user information entry screen;

FIG. 15 shows a display example on a delivery denial screen;

FIG. 16 is a flow diagram showing a search process; and

FIG. 17 is a flow diagram showing a billing process.

### DESCRIPTION OF THE PREFERRED EMBODIMENTS

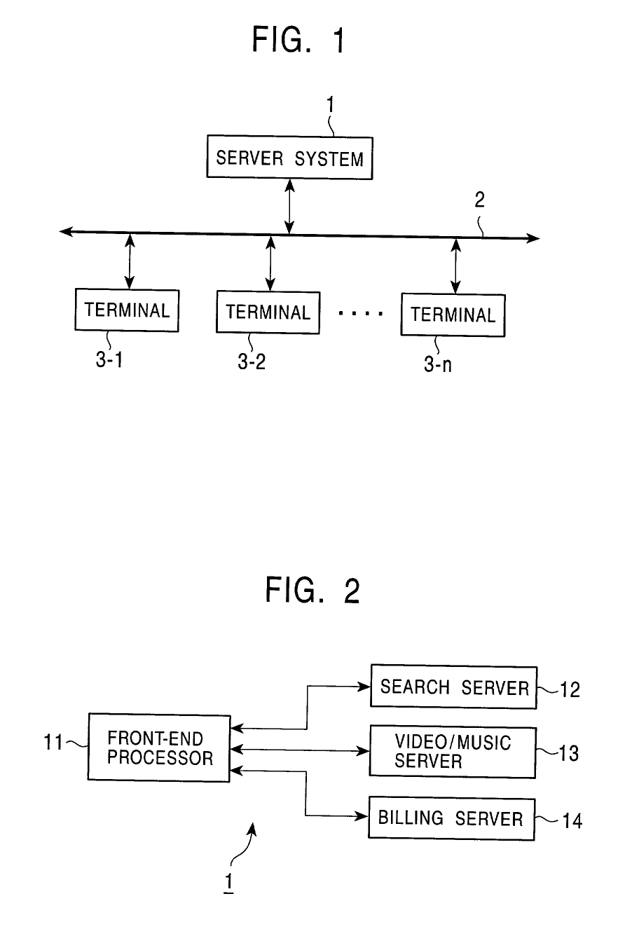

FIG. 1 shows a search system implementing the present invention. The search system includes terminals 3-1 through 3-n (when there is no need for individually identifying the terminals 3-1 through 3-n, each of these is collectively referred to as a terminal 3) and a server system 1 to which the terminals 3 are respectively connected through the Internet 2.

The server system 1, composed a plurality of computers, performs content search process to be discussed later, in accordance with a server program and a CGI (Common Gateway Interface) script. The server system 1 bills a search fee of a content or a delivery fee of a content to the terminal 3.

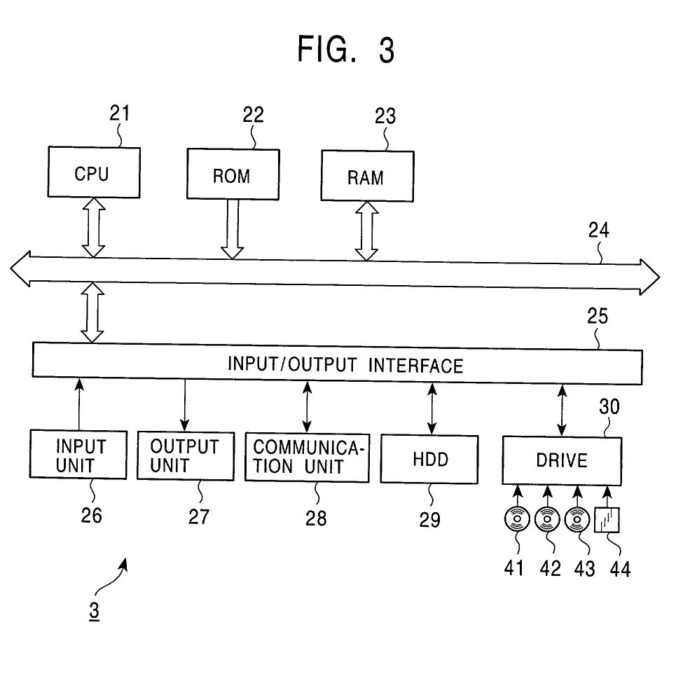

The terminal 3, being a computer, executes a program of a WWW (World Wide Web) browser stored in a hard disk drive (HDD) 29 with a CPU 21 (see FIG. 3) thereof. In response to a command from a user, the WWW browser executed by the terminal 3 accesses a home page opened by the server system 1, receiving an HTML (Hyper Text Markup Language) transmitted from the server system 1 through the Internet 2, and outputting an image corresponding to the HTML file on an output unit 27 (see FIG. 3).

FIG. 2 is a block diagram showing the server system 1 in detail.

A front-end processor 11 outputs, to a search server 12, a search query (in a broad sense, the search query is a keyword for use in searching) transmitted from the terminal 3 through the Internet 2, while outputting search results from the search server 12 to the terminal 3 through the Internet 2. The search query includes a text relating to desired music or a desired video program, a voice, a singing voice, humming, the music, the video program, or a scene.

The front-end processor 11 notifies a video/music server 13 of a request to purchase a content or a request to prelisten (preview) a content, transmitted from the terminal 3. In response to the request, the front-end processor 11 delivers the read content to the terminal 3. The front-end processor 11 further notifies a billing server 14 of user information transmitted from the terminal 3, while sending billing information output from the billing server 14 to the terminal 3.

The search server 12 searches for a content in accordance with a search query input from the front-end processor 11. The search server 12 outputs a question to the front-end processor 11 as required.

The video/music server 13 stores all video programs and all pieces of music. The video/music server 13 reads a desired video and music in response to the content preview (prelisten) request or the content purchase request notified by the front-end processor 11.

The billing server 14 bills the terminal 3 in accordance with the user information notified by the front-end processor 11.

FIG. 3 is a block diagram showing the terminal 3 in detail. Each of the front-end processor 11, the search server 12, the video/music server 13, and the billing server 14 has a construction similar to that of the terminal 3, although the construction thereof is not shown.

The CPU (Central Processing Unit) 21 executes a variety of programs stored in ROM (Read Only Memory) 22 and a hard disk drive 29. A RAM (Random Access Memory) 23 stores programs and data which are required by the CPU 21 when the CPU 21 executes a variety of processes. The CPU 21, the ROM 22, and the RAM 23 are mutually interconnected to each other through a bus 24, and are also connected to an input/output interface 25.

The input/output interface 25 includes a keyboard, numeric keys, a mouse, a microphone, an input unit 26 composed of a digital camera, an LCD (Liquid Crystal Display), a CRT (Cathode Ray Tube), an output unit 27 composed of a loudspeaker, a communication unit 28 communicating with the Internet 2, and the hard disk drive 29. As necessary, the input/output interface 25 is connected to a drive 30 that is used to install a program. A magnetic disk 41, an optical disk 42, a magnetooptical disk 43, and a semiconductor memory 44 may be mounted on the drive 30.

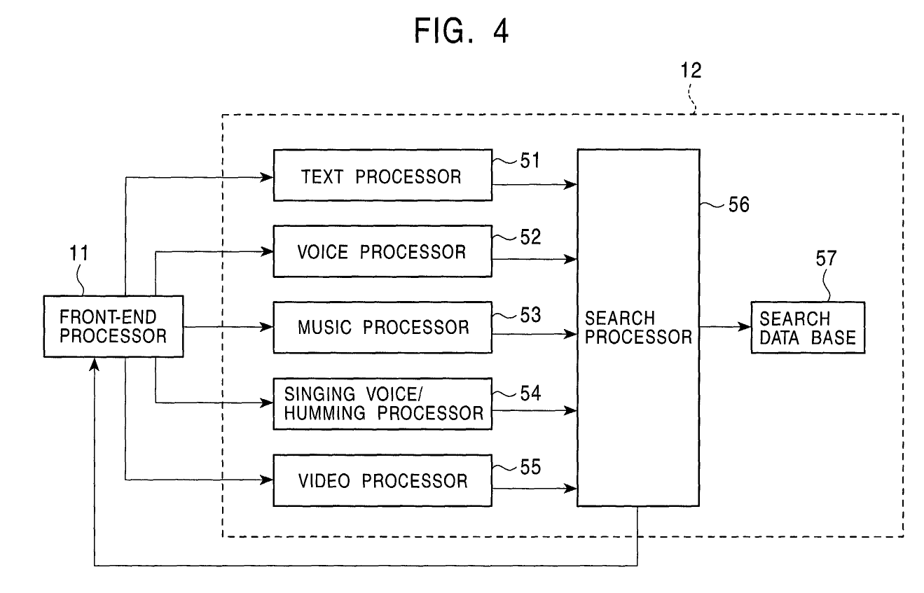

FIG. 4 is a block diagram showing the search server 12 in detail.

A text processor 51 performs a predetermined process on a search query expressed in text (information represented by characters) input from the front-end processor 11, and outputs the processed search query to a search processor 56. Specifically, the text processor 51 separates a plurality of search queries concurrently input, and generates a video/music feature quantity, and outputs the video/music feature quantity to the search processor 56. The video/music feature quantity generated here is the text itself.

The voice processor 52 performs a predetermined process on a search query of voice (information represented by the voice of a user) input from the front-end processor 11, and outputs the processed search query to the search processor 56. Specifically, the voice processor 52 converts an input voice or an input singing voice using a voice recognition technique, separates search queries if a plurality of search queries are concurrently input, generates a video/music feature quantity, and outputs the video/music feature quantity to the search processor 56. The video/music feature quantity is a text itself.

Details of voice recognition technique have been described in a book entitled “Acoustic/Phonetic Engineering” authored by Furui, and published by Kindaikgaku-sha, 1992, for example.

A music processor 53 performs a predetermined process on a search query of music (information representing music played in FM broadcasting, for example) input from the front-end processor 11, and outputs the processed search query to the search processor 56. Specifically, the music processor 53 extracts a music feature of the input music using a music analysis technique. The music feature generated here is numerical data such as an amplitude of an output from a bandpass filter (BPF) or a text representing a genre (such as rock, or classical music).

A method for extracting music feature is disclosed in U.S. Pat. No. 5,210,820 to Kenyon, entitled “Signal Recognition System and Method”, and a method for identifying a genre of music has been proposed in a paper entitled “Genre Classification System of TV Sound Signals Based on a Spectrogram Analysis”, authored by Han, IEEE Trans. on Consumer Electronics, Vol. 44, No. 1, 1998.

A singing voice/humming processor 54 performs a predetermined process on a search query of a singing voice (information representing lyric or a melody sung by the user's own voice) or humming (information representing a melody sung by the user's own voice), input from the front-end processor 11, and outputs the processed search query to the search processor 56. Specifically, the singing voice/humming processor 54 extracts a feature quantity representing a melody of the music using a feature extraction method from performance played by the user himself, rather than performance played by the music's original player. The music feature is numerical data expressing the frequency tone and musical intervals of a musical note, and is expressed in the MIDI format, for example.

A method of extracting humming feature quantity has been proposed in a paper entitled “Music Search System, Data Base System Using Humming” authored by Kosugi et al., 119-9, Information Processing Society of Japan, 1999.

A video processor 55 performs a predetermined process on a search query of a video (information represented by a moving image) or an image (information represented by a still image) input from the front-end processor 11, and outputs the search query to the search processor 56. Specifically, the video processor 55 extracts a feature quantity from a television-broadcast video, a recorded video clip, a one-frame video, or an image sketched a user himself input from the front-end processor 11. The video feature quantity generated here is a color histogram, an outline, or a motion vector of the video, and is represented in numerical data.

A method for extracting a video feature quantity is detailed for example in a paper entitled “Automatic Video Indexing and Full-Video Search for Object Appearances,” authored by Nagasaka, Trans. Vol. 33, No. 4, pp.543-50, 1992 published by the Information Processing Society of Japan.

In accordance with the following equation (1), the search processor 56 calculates the degree of similarity between each of all video programs and music feature quantities stored in a search data base 57 and the input video program/music feature quantity, based on the input video program/music feature quantity respectively input from the text processor 51 through the video processor 55.

R_{xy}=(number of character matches)/(length of a search query) (1)

Equation (1) is used when the degree of similarity is calculated from the feature quantity in text format. When the degree of similarity is calculated from the feature quantity in a numerical data format, equation (2) is used.

R_{xy}=(xy)/√(|x|²|y|²) (2)

where x represents the feature quantity of input video program or input music, and y represents the feature quantity of video or music stored in the search data base 57.

Based on the degree of similarity R_{xy} calculated from equation (1) or (2), the search processor 56 detects music having a full match (R_{xy}=1), or music or a video program having a close match (0<R_{xy}<1), and outputs these pieces of information as a candidate list.

The search data base 57 is formed of a storage device such as a hard disk drive or magnetooptical disk drive, and a control processor for controlling the disk. Feature quantities of video programs and music to be searched are registered beforehand, and are managed as a single or a small number of data records using a data base language such as SQL (Structured Query Language).

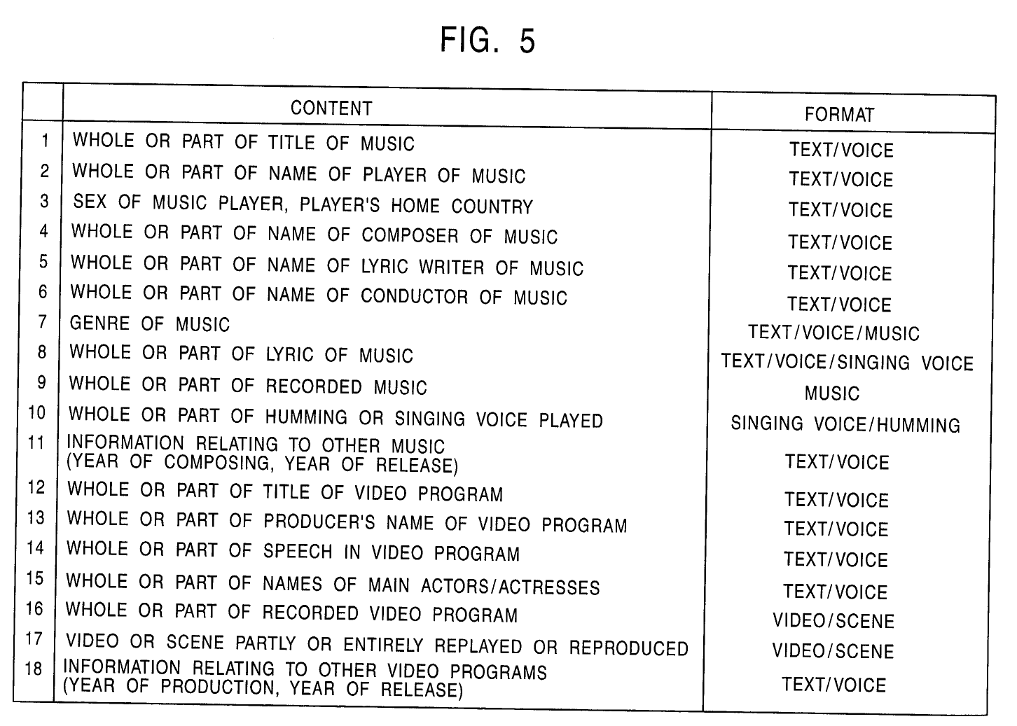

FIG. 5 shows examples of query input to the text processor 51 through the video processor 55 from the terminal 3.

As shown, a first entry is a search query indicating, in whole or in part, a title of music in a format of text or voice. A second entry is a search query indicating, in whole or in part, a player's name of music in a format of text or voice. A third entry is a search query indicating sex and a home country of the player in a format of text or voice. A fourth entry is a search query indicating, in whole or in part, a name of a composer of the music in a format of text or voice. A fifth entry is a search query indicating, in whole or in part, a name of a lyric writer of the music in a format of text or voice. A sixth entry is a search query indicating, in whole or in part, a name of a conductor of the music in a format of text or voice.

A seventh entry is a search query indicating a genre of the music in a format text or voice or music. An eighth entry is a search query indicating, in whole or in part, a lyric of the music in a format of text, voice, or singing voice. A ninth entry is a search query indicating, in whole or in part, recorded music in a format of music. A tenth entry is a search query indicating, in whole or in part, performance played by humming or singing voice in a format of singing voice or humming. An eleventh entry is a search query indicating information relating to other music (the year of composing, the year of release, etc.). A twelfth entry is a search query indicating, in whole or in part, a title of a video program in a format of text or voice.

A thirteenth entry is a search query indicating, in whole or in part, a producer's name of the video program in a format of text or voice. A fourteenth entry is a search query indicating, in whole or in part, speech in the video program in a format of text or voice. A fifteenth entry is a search query indicating, in whole or in part, the name of a main actor in the video program in a format of text or voice. A sixteenth entry is a search query indicating, in whole or in part, a recorded video program in a format of video or scene. A seventeenth entry is a search query indicating, in whole or in part, the video program or scene simulated or reproduced in a format of video or scene. An eighteenth entry is a search query indicating information relating to other video programs (the year of production, the year of release, etc.) in a format of text or voice.

As seen from the search queries listed in FIG. 5, the text processor 51 and the voice processor 52 respectively receive the search queries listed the first entry through the eighth entry, and from the eleventh entry through the fifteenth entry, and in the eighteenth entry. The music processor 53 receives the search queries listed in the seventh entry through the ninth entry. The singing voice/humming processor 54 receives the search query in the tenth entry. The video processor 55 receives the search queries listed in the sixteenth entry and the seventeenth entry.

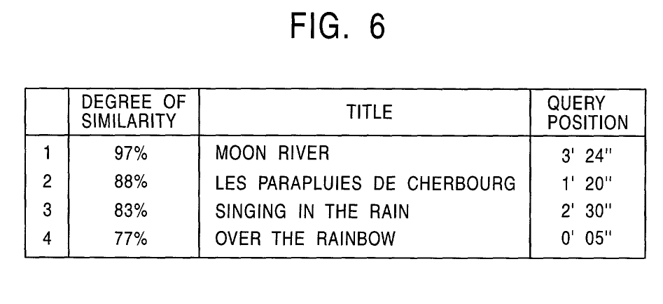

FIG. 6 shows an example of a candidate list output from the search processor 56.

Referring to FIG. 6, the first entry lists a content including 97% as the degree of similarity, “Moon River” as the title, and 3 minutes 24 seconds (hereinafter referred to as 3′24″) as a query position. The second entry lists a content including 88% as the degree of similarity, “Les Parapluies de Cherbourg” as the title, and 1′20″ seconds as a query position. The third entry list a content including 83% as the degree of similarity, “Singing in the Rain” as the title, and 2′30″ as a query position. The fourth entry lists a content including 77% as the degree of similarity, “Over the Rainbow” as the title, and 0′05″ as a query position.

Here, the query position refers to a position, similar to the position of the search query input by the user, in a video program or music registered in the search data base 57. For example, in the content in the first entry, there exists a position (a point of time), at the elapse of 3 minutes 24 seconds from the head (0 minute 0 second) of the music “Moon River,” similar to the search query input by the user, and the degree of similarity is 97%. The query position is used for prelistening or previewing during a search process to be discussed later.

The search query is a typically representative position (a scene having a title therewithin or a well-known portion of music) within a video program or music as a default value in the candidate list when the search query is a title from which no position is available unlike the video program or music.

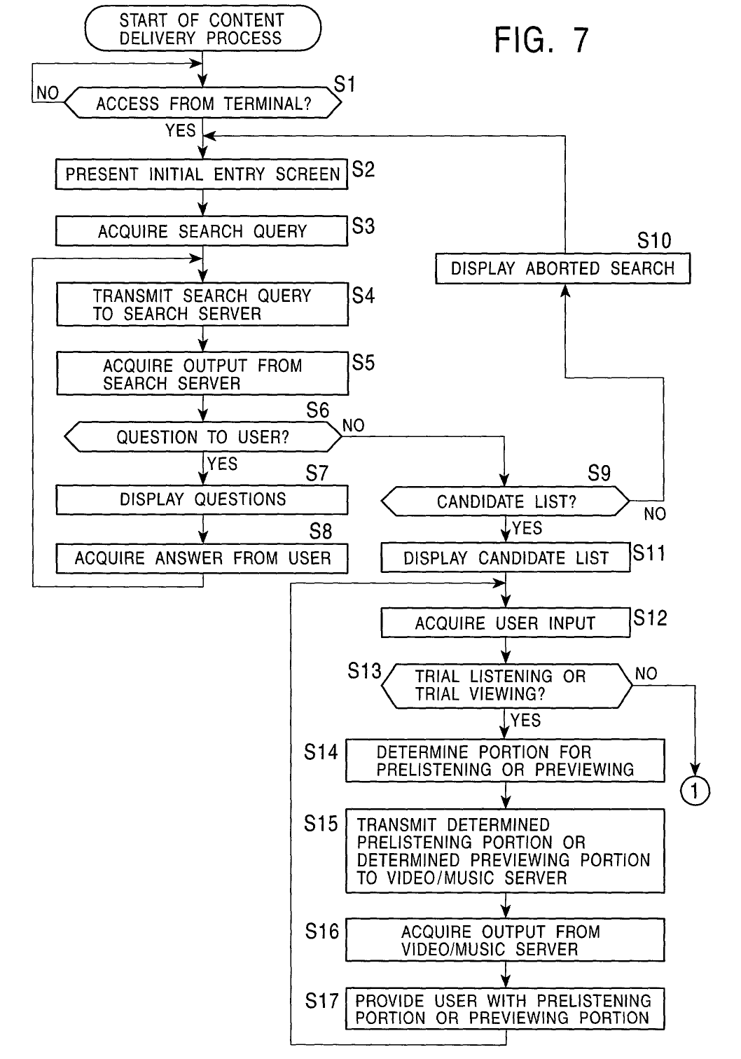

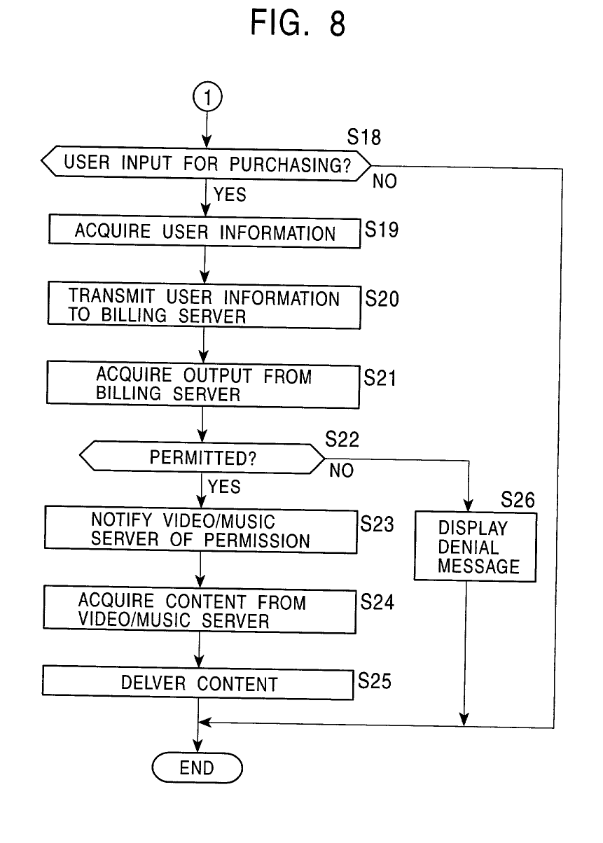

Referring to flow diagrams shown in FIG. 7 and FIG. 8, a delivery process of a content (a video program or music) carried out by the front-end processor 11 in the server system 1 will now be discussed.

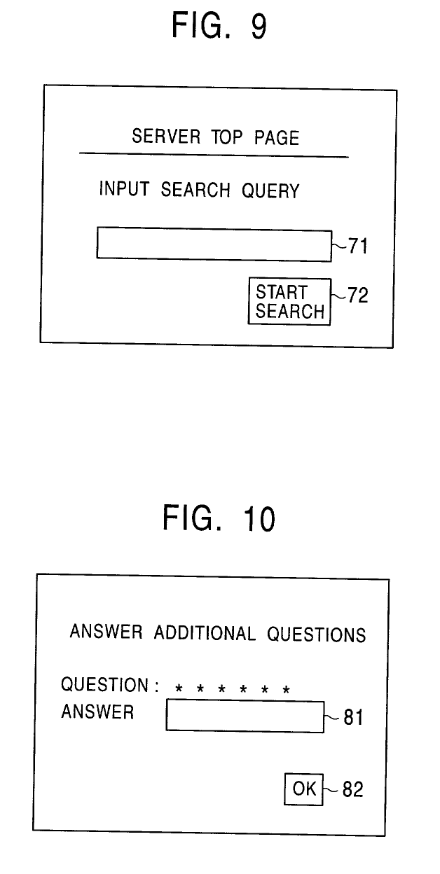

In step S1, the front-end processor 11 determines whether the server system 1 has been accessed by the terminal 3 through the Internet 2, and is on ready standby waiting for an access from the terminal 3. When the server system 1 is accessed by the terminal 3, the process proceeds to step S2. The front-end processor 11 delivers HTML files stored in the hard disk drive thereof to the terminal 3 through the Internet 2. In this way, the output unit 27 of the terminal 3 presents an initial entry screen shown in FIG. 9.

Referring to FIG. 9, a search query entry area 71 is displayed on the initial entry screen. The user of the terminal 3 uses the input unit 26, inputting a search query in the search query entry area 71. When the user presses a search start button 72, the search query is entered in the server system 1. The user not only enters the search query such as a text, but also inputs a voice, a singing voice, or humming, or even a video or a scene using a digital camera.

Referring to FIG. 7, in step S3, the front-end processor 11 acquires the search query transmitted from the terminal 3 through the Internet 2. In step S4, the front-end processor 11 sends the search query acquired in step S3 to the search server 12. The search server 12 performs a search process to be discussed later based on the search query supplied from the front-end processor 11, and outputs search results.

In step S5, the front-end processor 11 receives an output from the search server 12. In step S6, the front-end processor 11 determines whether the output from the search server 12 is a question to the user. When the front-end processor 11 determines that the output of the search server 12 is a question to the user, the process proceeds to step S7.

In step S7, the front-end processor 11 transmits an HTML file relating to the question from the search server 12 to the terminal 3 through the Internet 2. The output unit 27 of the terminal 3 presents a display shown in FIG. 10.

FIG. 10 shows the question to the user of the terminal 3 and an answer entry area 81. The user, who has acknowledged the question, enters an answer (an additional search query) in the answer entry area 81, and presses an OK button 82. The answer to the question is thus sent to the server system 1.

Returning to FIG. 7, in step S8, the front-end processor 11 receives the answer (the additional search query) transmitted from the terminal 3 through the Internet 2, and returns to step S4, thereby start over the above-referenced steps.

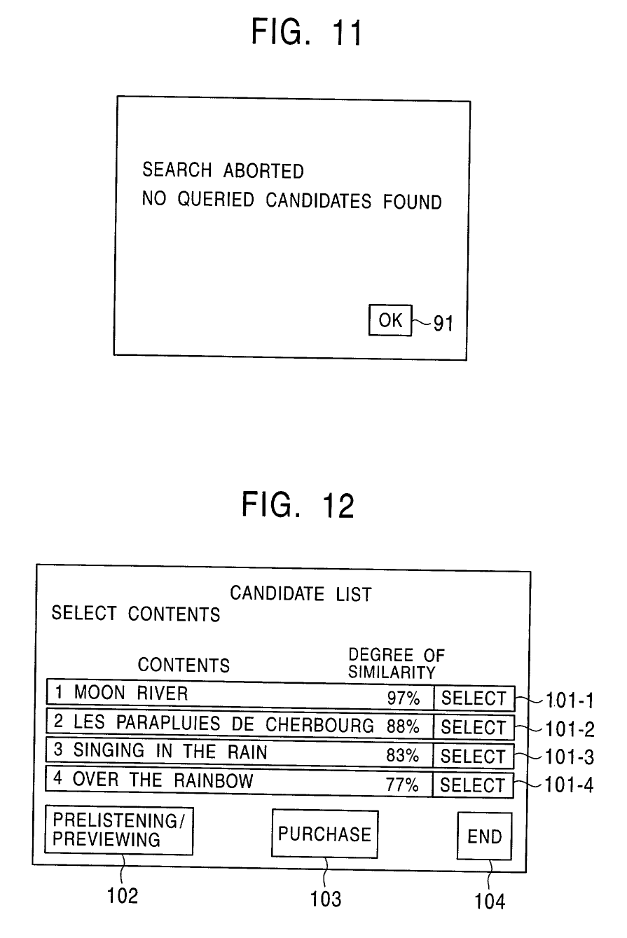

When it is determined in step S6 that the output of the search server 12 in step S5 is not a question to the user, the process proceeds to step S9. The front-end processor 11 determines whether the output of the search server 12 is a candidate list. When it is determined in step S9 that the output of the search server 12 is not a candidate list, the front-end processor 11 sends an HTML file relating an aborted search to the terminal 3. The output unit 27 of the terminal 3 presents a display shown in FIG. 11.

FIG. 11 shows a message saying “Search Aborted. No Queried Candidates Found.” The user, who acknowledges this message, presses an OK button 91. The output unit 27 of the terminal 3 returns to the initial entry screen shown in FIG. 9.

When it is determined in step S9 that the output of the search server 12 is a candidate list, the process proceeds to step S11. The front-end processor 11 delivers an HTML file relating to the candidate list to the terminal 3 through the Internet 2. In this way, the output unit 27 of the terminal 3 presents a candidate list screen as shown in FIG. 12.

Referring to FIG. 12, the candidate list tables the names of the contents and the degrees of similarity in the order from a high degree to a low degree of similarity. The user of the terminal 3 selects any of the contents using select buttons 101-1 through 101-4. By pressing either a prelistening/previewing button 102 or a purchase button 103, the user requests the prelistening/previewing of a pre determined content or purchase of the predetermined content. When an end button 104 is pressed, the output unit 27 of the terminal 3 returns to the initial entry screen shown in FIG. 9.

Returning to FIG. 7, in step S12, the front-end processor 11 receives a user input (for prelistening/previewing, purchasing, or an end) sent from the terminal 3 through the Internet 2.

In step S13, the front-end processor 11 determines whether the user input acquired in the process step in step S12 is for prelistening or previewing. When it is determined that the user input is for prelistening or previewing, the process proceeds to step S14. In step S14, the front-end processor 11 determines a prelistening portion or a previewing portion based on the query position in the candidate list shown in FIG. 6. Since the query position is described in the candidate list in a search process to be discussed later, a predetermined segment containing the query position is determined to be a prelistening portion or a previewing portion.

For example, when a prelistening of “Moon River” listed in the first entry as shown in FIG. 6 is requested, the front-end processor 11 determines a predetermined segment starting with the query position of the content at 3 minutes 24 seconds as a prelistening portion. The segment of the content thought of by the user is thus used for a prelistening portion or a previewing portion. The user thus effectively recognizes the content within a short period of time.

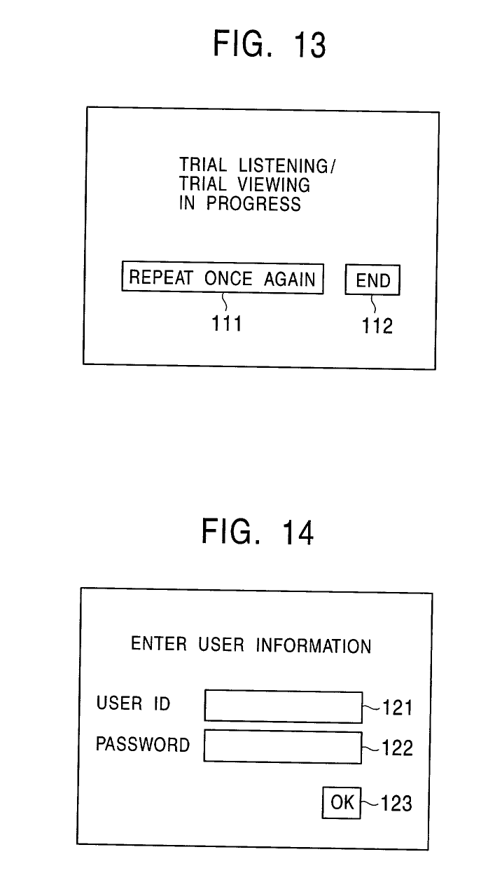

In step S15, the front-end processor 11 sends the prelistening portion or the previewing portion, determined in step S14, to the video/music server 13. The video/music server 13 reads the predetermined prelistening portion or the previewing portion based on the prelistening portion or the previewing portion provided by the front-end processor In step S16, the front-end processor 11 receives the prelistening portion or the previewing portion of the content read from the video/music server 13. In step S17, the front-end processor 11 provides (transmits) the prelistening portion or the previewing portion of the content acquired in step S16 to the terminal 3 through the Internet 2. The output unit 27 of the terminal 3 shows a screen shown in FIG. 13.

Referring to FIG. 13, the prelistening portion or the previewing portion of the content is reproduced (output). When the user, who has prelistened or have previewed the content, presses a “Repeat Once Again” button 111, the prelistening portion or the previewing portion of the content is repeated. Upon pressing an end button 112, the output unit 27 of the terminal 3 returns to the candidate list screen shown in FIG. 12.

Returning to FIG. 7, when it is determined in step S13 that the user input received from the terminal 3 in step S12 is neither a prelistening request nor a previewing request, the process proceeds to step S18. The front-end processor 11 determines whether the user input from the terminal 3 is a purchase command.

When the purchase button 103 shown in FIG. 12 is pressed, the output unit 27 of the terminal 3 shows a display something like the one shown in FIG. 14. Referring to FIG. 14, the a message saying “Enter User Information” to the user of the terminal 3 appears. Also shown together are a user ID entry area 121 and a password entry area 122. The user of the terminal 3 enters a user ID in the user ID entry area 121, while entering the password of the user ID in the password entry area 122. When an OK button 123 is pressed, the user information is input to the server system 1. For example, the user ID may be a credit card number of the user's or a mobile telephone number of the user's.

Returning to FIG. 8, when it is determined in step S18 that the user input is a purchase command, the process proceeds to step S19. The front-end processor 11 acquires the user information transmitted from the terminal 3 through the Internet 2. In step S20, the front-end processor 11 sends the user information acquired in step S19 to the billing server 14. Based on the user information supplied from the front-end processor 11, the billing server 14 performs a billing process and outputs process results.

The front-end processor 11 receives the output of the billing server 14 in step S21. In step S22, the front-end processor 11 determines whether the output of the billing server 14 acquired in step S21 is a “permission”, and when the front-end processor 11 determines that the output of the billing server 14 is a “permission,” the process proceeds to step S23.

In step S23, the front-end processor 11 notifies the video/music server 13 that the output of the content is permitted. Upon receiving the notification of the permission from the front-end processor 11, the video/music server 13 reads the predetermined content to be sold.

In step S24, the front-end processor 11 acquires the content read by the video/music server 13. In step S25, the front-end processor 11 delivers the content acquired in step S24 to the terminal 3 through the Internet 2.

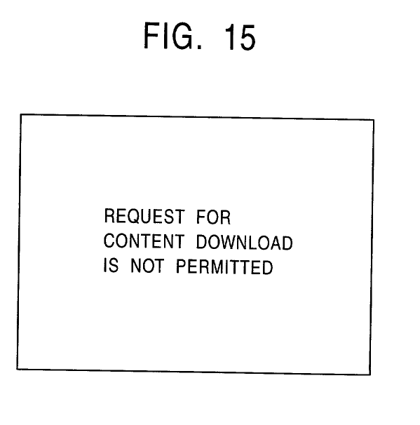

When it is determined in step S22 that the output of the billing server 14 acquired in step S21 is a “denial,” the process proceeds to step S26. The front-end processor 11 delivers an HTML file relating to the “denial” to the terminal 3 through the Internet 2. The output unit 27 of the terminal 3 presents a screen shown in FIG. 15.

Referring to FIG. 15, a message saying “the request for the content download is not permitted” is presented to the user of the terminal 3.

The content to be searched is thus narrowed by repeating questions in response to the search query input by the user in the delivery process of the content.

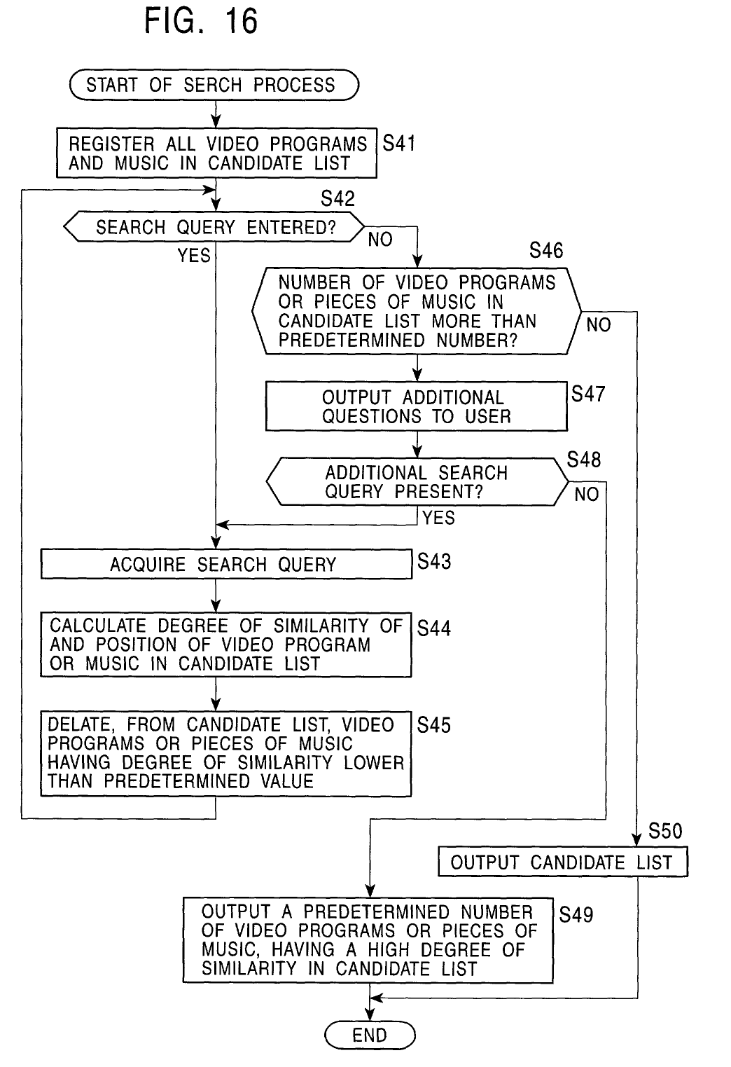

Referring to the flow diagram shown in FIG. 16, the search process carried out by the search processor 56 of the search server 12 will now be discussed.

In step S41, the search processor 56 registers, in the candidate list, feature quantities of all video programs and all pieces of music stored in the search data base 57. In step S42, the search processor 56 determines whether the vide/music feature quantities (search queries) generated from the text processor 51 through the video processor 55 are input. When the search processor 56 determines that the feature quantities are input, the process proceeds to step S43.

In step S43, the search processor 56 acquires the search query processed in step S42. In step S44, the search processor 56 calculates the degree of similarity R_{xy} between the search query (video/music feature quantity) acquired in step S43 and the feature quantities of all video programs and all pieces of music stored in the candidate list in accordance with equation (1) or (2).

In step S45, the search processor 56 deletes, from the candidate list, contents processed in step S44 and having the degrees of similarity R_{xy} not more than a predetermined degree of similarity. The process returns to step S42. The above discussed steps are then repeated. Any value may be set to the threshold of the degree of similarity below which the contents are deleted from the candidate list.

When it is determined in step S42 that no search query has been input, the process proceeds to step S46. The front-end processor 11 determines whether the number of video programs or the number of pieces of music is not less than a predetermined number (ten, for example). When the front-end processor 11 determines that the number of video programs or the number of pieces of music is not less than the predetermined number, the process proceeds to step S47. The search processor 56 outputs, to the front-end processor 11, an additional question to the user of the terminal 3.

The front-end processor 11 delivers the additional question from the search processor 56 to the terminal 3 via the Internet 2, and the output unit 27 of the terminal 3 presents the screen shown in FIG. 10. The user, who recognizes the screen, enters an answer (an additional search query) in the answer entry area 81. When the user presses the OK button 82, the answer to the question is transmitted to the server system 1.

When the search processor 56 determines in step S48 that the additional search query has been received, the process proceeds to and starts over with step S43.

When it is determined in step S48 that no additional query has been input, the process proceeds to step S49. The search processor 56 outputs video programs or music of a predetermined number (ten, for example) having a high degree of similarity in the candidate list to the front-end processor 11. The number of video programs or the number of pieces of music output to the front-end processor 11 is set to be any number.

When it is determined in step S46 that the number of video programs or the number of pieces of music in the candidate list is not more than the predetermined number, the process proceeds to step S50. The search processor 56 outputs the candidate list to the front-end processor 11 and the process ends.

In the search process, questions are made to the user until the number of contents in the candidate list falls within the predetermined number so that the contents to be searched are narrowed. When no answer (no additional search query) is provided to the question, the contents having high degree of similarity may be treated as search results.

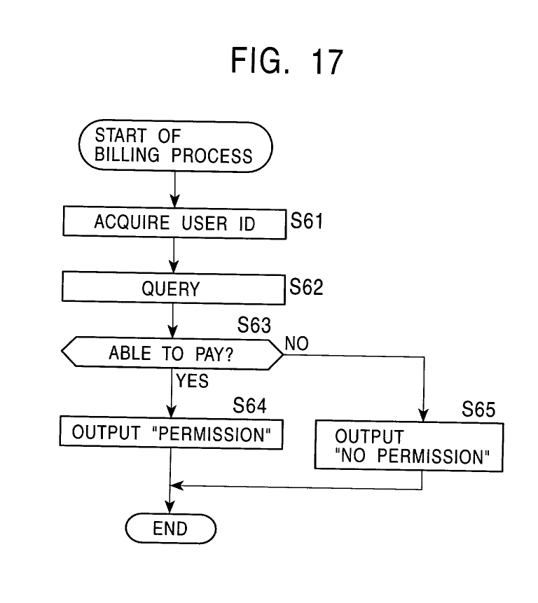

Referring to a flow diagram shown in FIG. 17, a billing process carried out by the billing server 14 will now be discussed. This process starts over when the determination result in step S18 in FIG. 8 is Yes (the user output is a purchase command).

In step S61, the billing server 14 receives the user information transmitted from the front-end processor 11, and acquires the user ID contained in the user information. In step S62, the billing server 14 checks with an network operator (not shown) about the user's ability to pay in accordance with the user ID acquired in step S61.

In step S63, the billing server 14 receives a reply from the network operator, and determines whether the user has the ability to pay. When the billing server 14 determines that the user has the ability to pay, the process proceeds to step S64. The billing server 14 outputs a “permission” to the front-end processor 11. When the billing server 14 determines in step S63 that the user of the terminal 3 has no ability to pay, the process proceeds to step S65. The billing server 14 outputs a “denial” to the front-end processor 11. The process ends.

The user is thus identified and the method of payment is determined based on the user ID acquired through the front-end processor 11 in the billing process. Available as payment methods are by a credit card, or by an alternative payment by a network operator.

In the above embodiment, the search process is carried out through the Internet 2. The present invention is not limited to the Internet 2. The search process may be performed through a wired communication such as a cable television, or through a radio communication such as ground waves or satellite broadcasting. In the radio communication, the terminal 3 may be a mobile telephone or a PDA (Personal Digital Assistant).

The server system 1 repeats questions in response to vague information requested by the user, thereby narrowing the search conditions. The present invention provides the following advantages.

(1) A video program or music is searched in an electronic video delivery system or an electronic music delivery system using fuzzy information that cannot be designated using a keyword.

(2) The user can prelisten desired music or preview a desired video program prior to purchasing.

(3) The user can select desired commodities based on a fuzzy image through interaction with the network.

The series of the above-referenced process steps may be carried out by dedicated hardware components. Alternatively, the process steps may be performed using a software program. When a software program is used to perform the process steps, the software program may be installed from a storage medium to a computer which is incorporated in dedicated hardware, or to a general-purpose computer which performs a variety of functions with a diversity of software programs installed therewithin.

As shown in FIG. 3, the storage medium may be package medium that is supplied to provide the user with the software program, separately from a computer. The package medium may be a magnetic disk 41 (such as a floppy disk), an optical disk 42 (such as a CD-ROM (Compact Disk Read Only Memory), or a DVD (Digital Versatile Disk)), a magnetooptical disk 43 (such as an MD (Mini-Disk)) or a semiconductor memory 44. The storage medium may also be the ROM 22 or a hard disk drive 29, each of which already stores a program and supplied in a computer.

The process steps describing the program stored in the storage medium are performed in a chronological order described above. Alternatively, the process steps may be performed in parallel or individually rather than in the chronological order described above.

The system in this specification refers to an entire system including a plurality of apparatuses.

In accordance with the present invention, the degree of similarity of the contents registered in the candidate list are calculated in accordance with the search conditions input from the other apparatus, a content having the degree of similarity smaller than a predetermined threshold is deleted from the candidate list. When the total number of contents remaining in the candidate list is equal to or larger than a predetermined number, a question is presented to the other apparatus. Based on the additional search condition input from the other apparatus, the degree of similarity is further calculated. A content about which the user has a vague idea is searched in an interactive fashion.

In accordance with the information processing system of the present invention, the first information processing apparatus calculates the degree of similarity of the contents registered in the candidate list according to search conditions input from the second information processing apparatus. The first information processing apparatus deletes a content from the candidate list when it is determined that the degree of similarity of the content calculated by the calculation unit is smaller than a predetermined threshold. The first information processing apparatus presents a question to the second information processing apparatus when the total number of contents remaining in the candidate list is equal to or larger than a predetermined number. The second information processing apparatus transmits, to the first information processing apparatus, the search conditions for searching the contents, and further transmits, to the first information processing apparatus, an additional search condition when answering the question received from the first information processing apparatus.

What is claimed is:

1. An information processing apparatus comprising:
storage means for storing a candidate list in which contents are registered;
calculation means for calculating the degrees of similarity of the contents registered in the candidate list according to search conditions input from the other apparatus;
deleting means for deleting a content from the candidate list when it is determined that the degree of similarity of the content calculated by the calculation means is smaller than a predetermined threshold;
and presentation means for presenting a question to the other apparatus when the total number of contents remaining in the candidate list as a result of the deletion by the deleting means is equal to or larger than a predetermined number,
wherein when the question is presented, the calculation means further calculates the degrees of similarity of the contents registered in the candidate list according to search conditions additionally input from the other apparatus.

2. An information processing apparatus according to claim 1, further comprising transmitter means for transmitting the candidate list to the other apparatus when the total number of contents remaining in the candidate list as a result of the deletion by the deleting means is smaller than the predetermined number, and
delivery means for delivering the content to the other apparatus when a request to supply the content registered in the candidate list transmitted from the transmitter means is received from the other apparatus.

3. An information processing apparatus according to claim 2, further comprising:
acquisition means for acquiring user information from the other apparatus, and
authentication means for authenticating the user information acquired by the acquisition means,
wherein the delivery means delivers the content based on the authentication result provided by the authentication means.

4. An information processing apparatus according to claim 1, further comprising recording means for recording, in the candidate list, the degree of similarity calculated by the calculation means, and a position having a similarity in the content.

5. An information processing apparatus according to claim 1, wherein the content contains one of video data and music data.

6. An information processing apparatus according to claim 1, wherein a format of the search condition contains a text, a text relating to music, a video program, a voice, a singing voice, humming, or music.

7. An information processing apparatus according to claim 1, wherein the search condition includes, in whole or in part, a title of music, a name of a player, a name of a composer, a name of a lyric writer, a name of a conductor, a genre of the music, lyric, the music, performance by humming or singing voice, information relating to the music, speech, a name of an actor, a video program, reproduction of the video program, and information relating to the video program.

8. An information processing method comprising the steps of:
storing a candidate list in which contents are registered;
calculating the degrees of similarity of the contents registered in the candidate list according to search conditions input from the other apparatus;
deleting a content from the candidate list when it is determined that the degree of similarity of the content calculated in the calculation step is smaller than a predetermined threshold;
and presenting a question to the other apparatus when the total number of contents remaining in the candidate list as a result of the deletion in the deleting step is equal to or larger than a predetermined number,
wherein when the question is presented, the calculation step further calculates the degrees of similarity of the contents registered in the candidate list according to search conditions additionally input from the other apparatus.

9. A storage medium for storing a computer readable program, the program comprising:
a program code for a step of storing a candidate list in which contents are registered;
a program code for a step of calculating the degrees of similarity of the contents registered in the candidate list according to search conditions input from the other apparatus;
a program code for a step of deleting a content from the candidate list when it is determined that the degree of similarity of the content calculated in the calculation step is smaller than a predetermined threshold;
and a program code for a step of presenting a question to the other apparatus when the total number of contents remaining in the candidate list as a result of the deletion in the deleting step is equal to or larger than a predetermined number,
wherein when the question is presented, the calculation step further calculates the degrees of similarity of the contents registered in the candidate list according to search conditions additionally input from the other apparatus.

10. An information processing system comprising a first information processing apparatus and a second information processing apparatus,
wherein the first information processing apparatus comprises:
storage means for storing a candidate list in which contents are registered,
calculation means for calculating the degrees of similarity of the contents registered in the candidate list according to search conditions input from the second information processing apparatus;
deleting means for deleting a content from the candidate list when it is determined that the degree of similarity of the content calculated by the calculation means is smaller than a predetermined threshold; and
presentation means for presenting a question to the second information processing apparatus when the total number of contents remaining in the candidate list as a result of the deletion by the deleting means is equal to or larger than a predetermined number; and
the second information processing apparatus comprises:
first transmitter means for transmitting, to the first information processing apparatus, the search conditions for searching the contents;
receiver means for receiving the question presented by the first information processing apparatus; and
second transmitter means for transmitting, to the first information processing apparatus, an additional search condition when answering the question received from the receiver means.
